(19) United States
(12) Patent Application Publication
(10) Pub. No.: US 2012/0291756 A1
(43) Pub. Date: Nov. 22, 2012

(54) Two-Stroke Internal Combustion Engine with Three Chambers

(75) Inventor: Paul A. Howard, Reston, VA (US)

(73) Assignee: Paul Allen Howard, Reston, VA (US)

(21) Appl. No.: 13/463,472

(22) Filed: May 3, 2012

Related U.S. Application Data
(60) Provisional application No. 61/482,810, filed on May 5, 2011.

(51) Int. Cl. F02D 15/04

(52) U.S. Cl. 123/48 D

(57) ABSTRACT

A two-stroke internal combustion engine is disclosed. Fuel efficiency is improved and extended over a wide power band by an inlet valve which controls the air charge. This inlet valve also varies the volume of the combustion chamber and thus maintains a constant compression ratio. A stoichiometric air/fuel mixture can be maintained at low power. An integrated positive displacement supercharger provides adequate air charge at all power levels and recovers compressor power from unused supercharged air. The capacity of the supercharger is reduced at low power level. An integrated secondary expansion chamber extends the power stroke by mixing combustion gases with ambient air for farther expansion and power production. The secondary expansion chamber allows simultaneous purging and charging of the combustion chamber. An alternate embodiment with opposed cylinders provides nearly continuous power.

### CROSS-REFERENCE TO RELATED APPLICATIONS

This application claims the benefit under 35 USC 120 of the filing date of provisional application No. 61/482,810, filed on May 5, 2011 by the present inventor.

### STATEMENT REGARDING FEDERALLY SPONSORED RESEARCH OR DEVELOPMENT

There has been no federal funding for this project.

### REFERENCE TO SEQUENCE LISTING, A TABLE, OR A COMPUTER PROGRAM LISTING COMPACT DISC APPENDIX

Not applicable.

### BACKGROUND OF THE INVENTION

1. Field of Invention

This invention relates to reciprocating piston mechanisms such as internal combustion engines. The combustion chamber has a unique inlet air valve and volume adjuster. The engine has two other chambers; one chamber is a speed independent, self-regulating variable capacity supercharger. The other chamber is secondary expansion chamber that extends the power stroke to a volume greater than the combustion chamber and allows simultaneous purging and charging of the combustion chamber.

2. Description of Prior Art

An internal combustion engine is a machine that converts chemical energy to mechanical power. The chemical reaction produces heat and combustion gases which are converted to mechanical power. The engine controls and surrounds the chemical reaction. The present art has improved this conversion efficiency however the greatest energy loss is waste heat.

Better conversion and in particular, the hot exhaust gases, have been the target of many inventors.

A major improvement has been the addition of a turbocharger. Turbochargers extract energy in the exhaust stream that would otherwise be wasted. Turbochargers use a turbine in the exhaust stream to convert the exhaust manifold into a post-combustion chamber that salvages some the exhaust energy. The exhaust driven turbine then drives a compressor in the inlet manifold. The turbocharger increases the air pressure and density of the air charge. A turbocharger increases efficiency because it scavenges energy that would otherwise be lost and it increases power density because the same size engine can combust a greater mass of air/fuel.

As good as turbochargers are, they have some weaknesses: 1) They do not work at low power levels because the velocity of the exhaust gases is insufficient to drive the turbine; 2) At high power, they extract more power than needed to compress the inlet air charge; and 3) At high power the added boost increases the effective compression ratio and results in even higher energy content which is lost in the exhaust stream. One of the goals of my invention to correct these deficiencies.

U.S. Pat. No. 4,437,437 has a secondary expansion chamber to extend the power stroke. Erickson eliminates the simultaneous opening of the intake and exhaust valves. Erickson employed a suction chamber to aid in purging the combustion chamber. This improvement reduces the exhaust pressure to be below atmospheric to improve volumetric efficiency. In my design, the combustion chamber and secondary expansion chamber are always at or above atmospheric pressure.

U.S. Pat. No. 5,341,774 is closer to a Wankel engine than a reciprocating engine with pistons. Erickson demonstrated improved fuel efficiency by extending the power stroke to another chamber. This is an supercharged version of an earlier patent. This engine has better fuel efficiency than a traditional two-stroke. It does not have a regenerative phase.

U.S. Pat. No. 4,767,287 has reciprocating piston movement and there are no connecting rods. However there is no supercharging, no multi-chambers and the cycle is not thermodynamically close to this invention.

U.S. Pat. No. 6,314,923 has opposed cylinders, used in a two-stroke engine without connecting rods. This invention uses poppet valves' to eliminate simultaneous port openings and the resultant fuel loss. Each cylinder supercharges its mate. The supercharger is not self regulated as in the present invention and supercharges the opposed cylinder. This necessitates lengthy gas passageways. There is no regeneration chamber.

U.S. Pat. No. 7,121,235 has many features contained in U.S. Pat. No. 6,314,923. Similarities are: double pistons used in pairs, reciprocating piston without connecting rods, self supercharging and secondary expansion. However Schmied increases the compression ratio whereas the invention disclosed here maintains a constant compression ratio. Schmied's claim 6 is similar to U.S. Pat. No. 5,341,774. Schmied's invention has secondary expansion chambers. He uses ducting and secondary valves to transport the gases to these chambers. Schmied operates the exhaust valves with a belt arrangement, see his FIG. 66. My invention operates the exhaust valves directly from the crankpin. Schmied combines exhaust gases from a common port for each cylinder pair. Then he directs the combustion gases to the other cylinder to assist in supercharging. This is effectively a positive displacement supercharger assist. In my engine, the combustion gases move directly to an encircling secondary expansion chamber. My invention also inducts fresh cold air into the secondary expansion for each cycle. The combustion gases then heat the trapped cold air for farther expansion.

The value of two-stroke engines is explained and improved by Springer, U.S. Pat. No. 5,526,778 who discloses an adjacent supercharger to improve the air flow through a combustion chamber. Two-stroke engines are farther improved by Hofbauer in U.S. Pat. No. 6,170,443 where he uses two opposed cylinders to provide smooth power with supercharged axial scavenging. He also solves a dynamic problem by balancing the opposed piston weight. Marks, U.S. Pat. No. 4,767,287, discloses a clever way to reduce friction in opposed two-stroke engines by utilizing an oscillating cylinder.

A three chamber diesel engine with opposed cylinders is described by Howard, US Patent application 2009-0165754. The present invention adds a variable capacity supercharger and extends the patent to include singe cylinder engines.

### BRIEF SUMMARY OF THE INVENTION

Accordingly, it is the object of the present invention to integrate into an engine many of the improvements and benefits prior inventors have sought. A novel engine geometry and motion will be disclosed which is efficient over a wide operating range. The proposed invention is a two-stroke internal combustion engine. The combustion chamber has a unique inlet valve that controls the air charge and maintains a constant compression ratio. The combustion chamber changes size. The combustion chamber is uniflow; the fresh air charge enters at one end and the spent combustion gases exit at the other end. Two annular cylinders encircle the combustion chamber. One annular cylinder is a self-regulating supercharger. The supercharger increases its capacity and pressure with increased engine throttle setting. The other annular cylinder is a secondary expansion chamber. The secondary expansion chamber improves efficiency by extending the power stroke and converting the thermal energy of the exhaust gases into increased pressure by heating cold air trapped inside the secondary expansion chamber. The secondary expansion chamber allows simultaneous charging and purging of the combustion chamber. The secondary expansion chamber reduces noise by slowly releasing the exhaust gases at a lower pressure and temperature.

### BRIEF DESCRIPTION OF THE DRAWINGS

FIGS. 1A & B show an isometric and sectional view of the Three Chamber Engine.

FIGS. 2A & B show an isometric and sectional view of the cylinder housing assembly.

FIGS. 3A & B show an isometric and sectional view of the double piston assembly.

FIG. 4 shows an isometric exploded view of the planetary crankshaft.

FIGS. 5 A-C show an isometric, exploded and sectional view of the throttle.

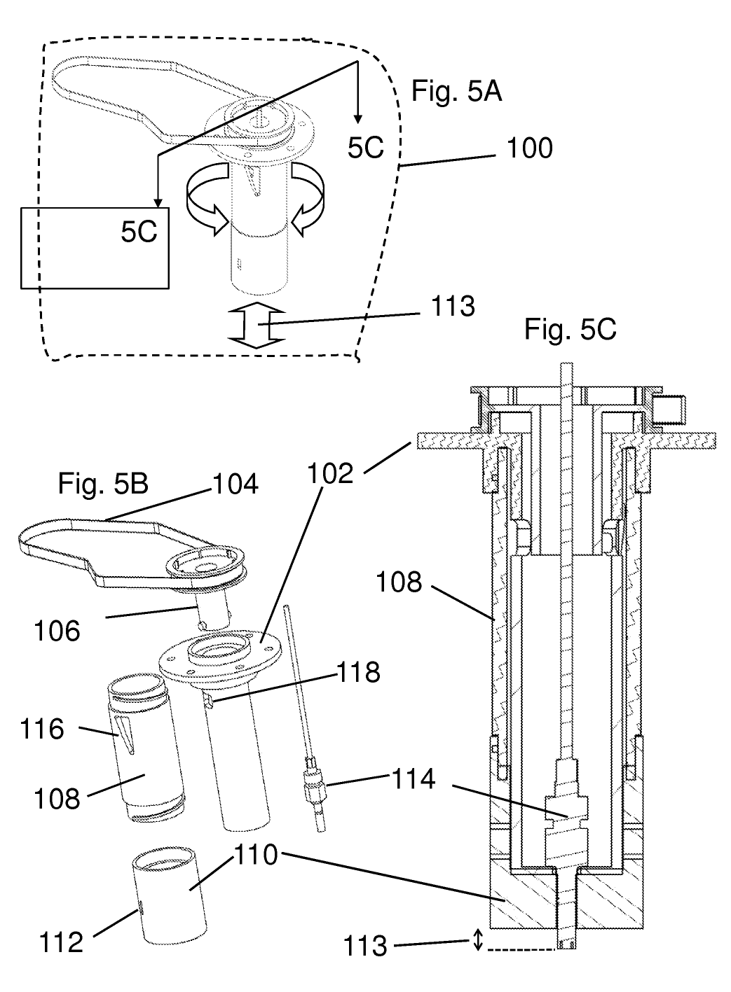

FIG. 6A shows a detailed partial sectional cut through the engine at BC with full power throttle. FIG. 6B shows the engine at partial power throttle.

FIGS. 7 A-C show the pressures in each chamber for a complete cycle.

### REFERENCE NUMERALS

30 three chamber engine

34 supercharger

38 cylinder housing assembly

42 secondary expansion chamber cylinder 44 fixed annular partition

46 air inlet port 48 reed valves

50 partition support 52 ring gear

54 double piston assembly

58 combustion chamber wall

62 transfer valve

66 secondary expansion chamber piston

70 trunnions

74 planetary gear

78 crankpin

80 main bearing

88 PTO shaft

102 throttle body

106 throttle drive shaft

110 inlet valve

113 inlet valve axial movement

116 riser vents

32 combustion chamber

36 secondary expansion chamber

40 supercharger cylinder

44 fixed annular partition

48 reed valves

52 ring gear

56 supercharger piston

60 combustion chamber inlet ports

64 transfer passageway

68 exhaust valves

72 planetary crankshaft

76 crank

82 exhaust valve cam

86 PTO bearing

100 throttle subassembly

104 throttle drive mechanism

108 riser

112 inlet valve slots

114 fuel injector

118 throttle body vent

### DETAILED DESCRIPTION OF THE INVENTION

### Convention

This description utilizes conventional terms used in the art. TC (Top Center) denotes when the combustion chamber is at minimum volume and ready for the combustion process. BC (Bottom Center) denotes that the combustion chamber is at maximum volume. It is understood that seals, bearings, guides, rings, valve keepers and other traditional parts in conventional engines are necessary and present. Cooling systems, lubrication, sensors, control systems and fuel injectors are complimentary and necessary technologies. The fuel used in this invention could be any of the traditional fuels used in internal combustion engines such as diesel, bio-fuel or gasoline. This invention will work well with any materials suitable for engine use. Cylinders are shown as circular but other shapes are practical. The preferred embodiment is compression ignition engines but these improvements are applicable with spark ignition engines. Consequently, this description does not labor the reader with such details

### Deficiencies of Present Engines

Compression ignition engines are more efficient than spark ignition engine primarily because of the higher compression ratios. Typical compression ignition engines have a compression ratio of 15 to 25 which is sufficient to heat the compressed air charge for ignition. The high compression ratio requires the same amount of air is taken in at all power levels. Compression ignition engines do not have throttles that reduce the air flow at low power. If they did, the reduced air charge might not have sufficient heating to guarantee ignition when the fuel is injected. At full power, there is a stoichiometic air/fuel mixture that is most efficient. At low power, there is more air than the fuel requires. This excess air reduces the peak burn temperature and efficiency. The ideal design would allow reduced air intake at low power but still maintain the high compression. This is only possible if the combustion chamber were smaller when there is reduced air intake. The engine disclosed here has a volume compensating valve that simultaneously reduces the air flow to the combustion chamber and reduces the volume. This unique feature allows a constant stoichiometic air/fuel mixture at all power levels.

Two-stroke diesel engines are the most efficient engines today. They combine the four processes: intake, compression, power and exhaust into two movements of the piston. The intake process occurs when the combustion chamber is near its maximum volume. Then the process of compression takes place where the air within the combustion chamber is compressed. The compression increases the air's temperature. Then at the end of this compression stroke and when the volume is smallest, fuel is injected. The power stroke begins when this fuel bums and the pressure increases farther. The piston reverses direction and the chamber gets larger. This power stroke continues until an exhaust valve opens and releases the combustion gases. Then, near the bottom of the stroke, a fresh air charge is forced into the combustion chamber. Then the piston reaches the end of its stroke, reverses direction and the compression process begins. The rapid events of exhaust and charging necessitate a compromise. The exhaust process ends the power stroke. Starting the exhaust process early to allow more time for exhaust reduces the duration of the of power stroke. This decreases efficiency. Likewise lengthening the intake process reduces the compression and efficiency. The solution would be to simultaneously exhaust the combustion gases and charge with fresh air. This is very difficult since the combustion chamber is open to the environment during the exhaust process. Hence the combustion chamber cannot be pressurized with fresh air. The initial air charge would be limited to the exhaust gas pressure. The only way to solve this problem is to have a second chamber connected to the combustion chamber to allow the exhaust gas pressure to increase. To be of practical value, this second chamber must extract power from the exhaust gases so the flow restriction does not reduce efficiency. The design disclosed here has that second chamber.

### Detailed Review of Drawings

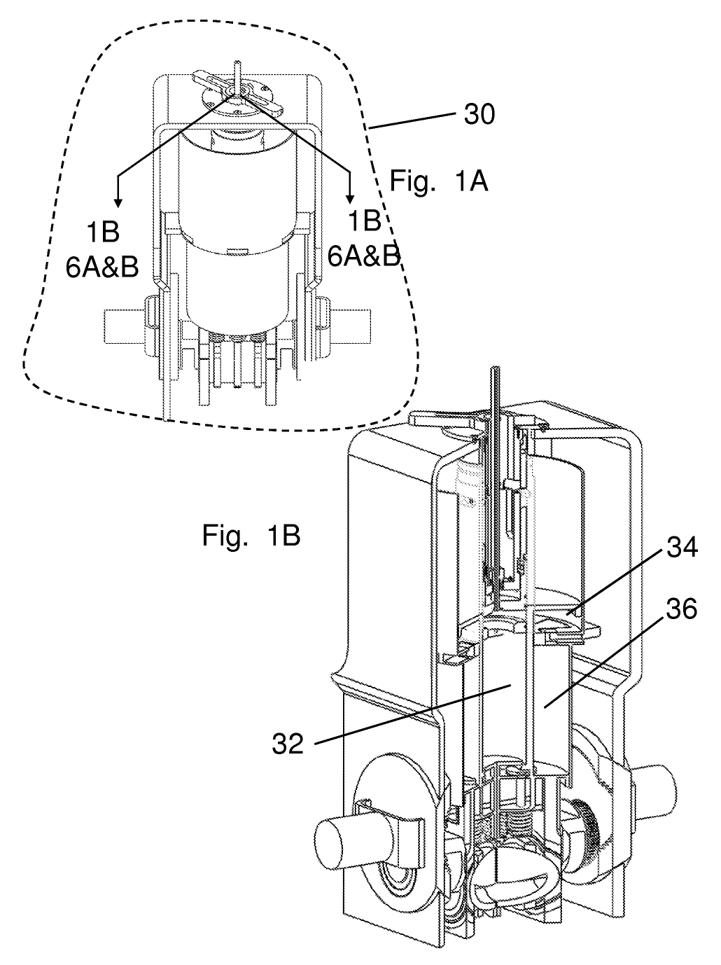

FIG. 1A shows an isometric view of the three chamber engine (30) as a single cylinder embodiment. Other embodiments are possible. An opposed cylinder design with two cylinders sharing a common crankpin has advantages over the single cylinder design. Likewise other multi-cylinder embodiments are possible. The sectional view, FIG. 1B, shows the three chambers. The combustion chamber, (32), is encircled by the supercharger, (34) and secondary expansion chamber (36). The engine has four major subassemblies: the cylinder housing assembly (38), the double piston assembly (54), the planetary crankshaft, (72) and the throttle subassembly (100). Each of these will be farther explained.

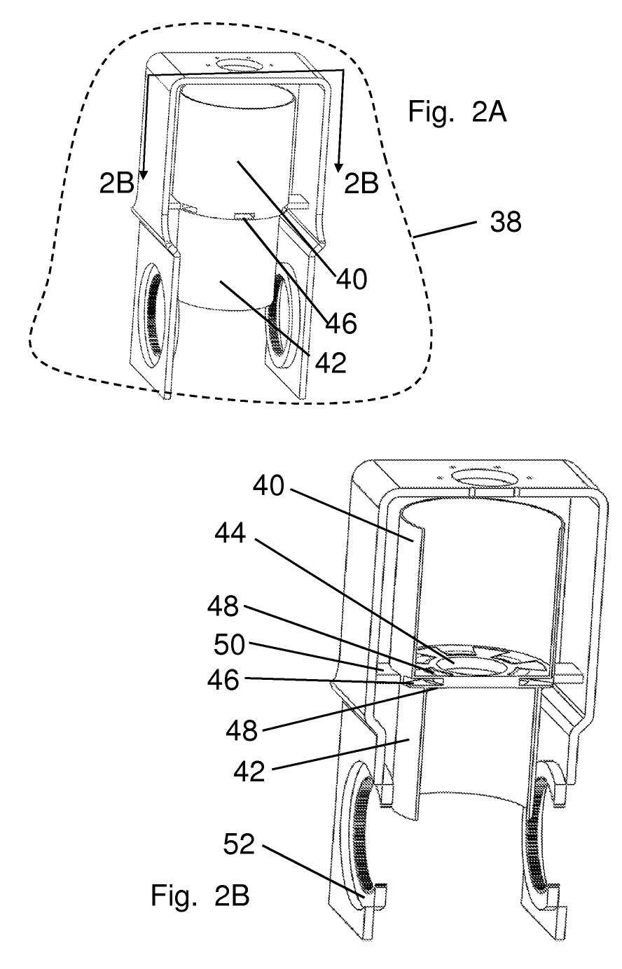

The cylinder housing assembly, (38) is essentially stationary but has active parts; it is shown in FIGS. 2A and 2B. The sectional view, FIG. 2B, reveals the supercharger cylinder, (40) and the secondary expansion chamber cylinder, (42). A fixed annular partition, (44), separates the partition incorporates the air inlets, (46), and reed valves, (48). Reed valves are one-way valves. They allow fresh air to enter the supercharger and secondary expansion chamber. A partition support, (50), is required to support the fixed partition. At least one ring gear, (52), is fixed to the frame.

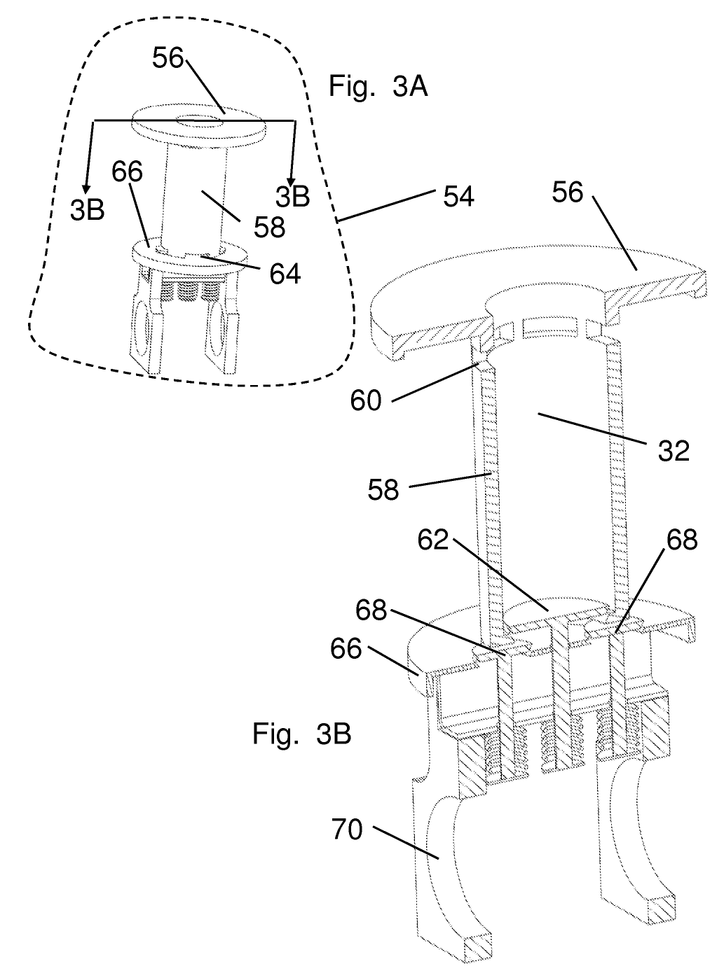

The double piston assembly, (54), is shown in FIG. 3A. A sectional view of the double piston assembly is shown in FIG. 3B. The supercharger piston, (56), is located near the end farther from the crankshaft. It is attached to the combustion chamber wall, (58). The combustion chamber, (32), is the volume within the combustion chamber wall. Combustion chamber inlet ports, (60), are located circumferentially in the combustion chamber wall near the supercharger piston. They are the passageways between the supercharger and combustion chamber. At the other end of the combustion chamber is a transfer valve, (62). Air enters the combustion chamber through the combustion chamber inlet ports, (60), and combustion gases exit through the transfer valve (62). Circumferential serrations near the bottom of the cylinder wall form the transfer passageways (64). The transfer passages allow the combustion gases to move to the secondary expansion chamber. The secondary expansion chamber piston, (66), is fixed to the end of the cylinder wall near the crankshaft. Exhaust valves, (68), are located in the secondary expansion chamber piston. These valves allow the combustion gases to exit the engine. Trunnions (70) are attached to the secondary expansion chamber piston. The trunnions allow rotary attachment to the planetary crankshaft, (72).

The double piston assembly reciprocates. It is located inside the cylinder housing and straddles the fixed partition. The supercharger chamber is the volume surrounded by the supercharger cylinder, bounded at one end by the supercharger piston, bounded at the other end by the fixed partition and on the inner surface by the combustion chamber wall. The volume of the supercharger will be typically 4 to 6 times greater than the combustion chamber. The secondary expansion chamber is the volume surrounded by the secondary expansion chamber cylinder, bounded at one end by the secondary expansion chamber piston, bounded at the other end by the fixed partition and on the inner surface by the combustion chamber wall. The volume of the secondary expansion chamber will be typically 3 to S times greater than the combustion chamber. The combined volume of the supercharger and secondary expansion chamber is constant. Since the double piston reciprocates, the volumes of the supercharger and secondary expansion chamber change complimentarily.

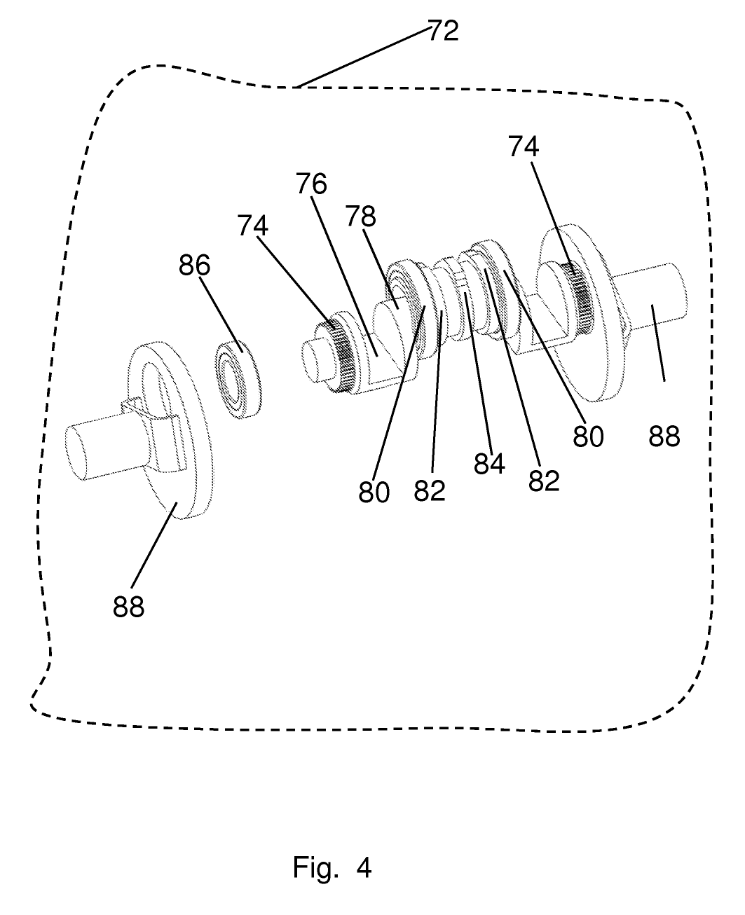

An exploded view of the planetary crankshaft, (72), is shown in FIG. 4. The planetary crankshaft is rotatably connected to the cylinder housing assembly with planetary gears, (74). The planetary gear is fixed to the crank, (76). The crank is fixed to the crankpin, (78) with an offset equal to ¼ of the engine stroke. The crankpin is rotatably connected to the trunnions with main bearings, (80). Cam lobes are fixed or machined onto the crankpin. The exhaust valve cam, (82), actuates the exhaust valve. The transfer valve cam, (84), actuates the transfer valve. The crank, (76), is connected to the PTO (power take off) bearing, (86). The PTO (power take off) shaft, (88), is rotatable connected to the crank through the PTO bearing. The PTO shaft is the means through which power is taken from or inserted into (i.e. starting) the engine.

The planetary gear engages with the ring gear of the cylinder housing assembly. The planetary gear has half as many teeth as the ring gear. Therefore the planetary gear makes two revolutions for each circuit of the ring gear. The resulting motion of the crankpin is both reciprocating and rotating. The reciprocating motion facilitates the conversion of expanding gases within the combustion chamber into torque on the crankshaft. The rotary motion of the crankpin allows the cam lobes to actuate the transfer and exhaust valves.

The throttle subassembly, (100), is shown in FIG. SA. An exploded view of the throttle subassembly is shown in FIG. SB. The throttle body, (102), is attached to the cylinder housing assembly. The throttle is actuated by the drive mechanism, (104); a belt is illustrated but any suitable means is equally practical Figure IB shows a lever to manipulate the throttle. The inlet valve is nearly fixed but has axial movement as controlled by the drive mechanism. The drive mechanism rotates a throttle drive shaft, (106), that in turn rotates the riser, (108). The riser engages the throttle body with helical threads or an axial cam. Therefore rotation of the riser results is axial (helical) motion. The riser also engages with the inlet valve, (110), with helical threads or axial cam of the opposite pitch. Rotation of the inlet valve is prevented with inlet valve slots (112). Pins are fixed to the throttle body, engage the inlet valve slots and allow only axial movement of the inlet valve (113). The sectional view of the throttle is shown in Fig. Sc. A fuel injector, (114), is connected to the throttle body, projects through the inlet valve and has a sliding seal between it and the inlet valve.

The riser position controls venting of the supercharger. At full power, the full motion of the supercharger piston is needed to fully charge the combustion chamber and there is no venting. At less than full power, less air charge is needed so the supercharger capacity and pressure must be proportionally reduced. The riser has triangular holes to facilitate supercharger venting. These triangular holes are the riser vents, (116), and extend partway down the riser. At lower power, the riser vents align with the combustion chamber inlets ports and the throttle body vent to create a flow path to the environment. Then at low throttle setting, the supercharger does not start its compression stroke until about half way through. The duration of the venting become smaller as the throttle is increased and there is less alignment of the vents and the combustion chamber inlet ports. Finally at full throttle there is no venting.

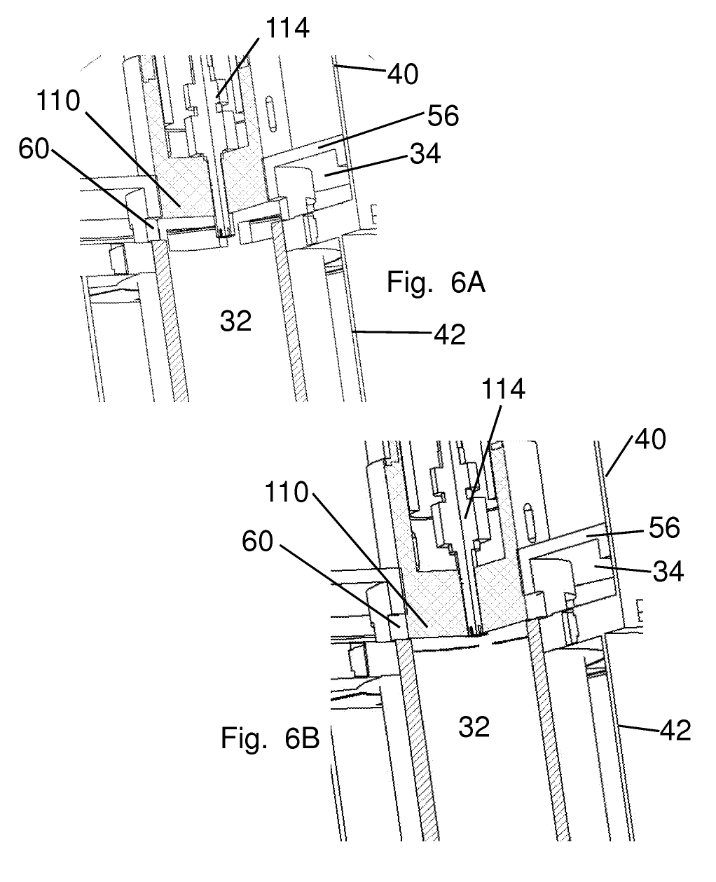

The rotational motion of the riser produces axial motion of the inlet valve (113) as illustrated in Fig. SA. This movement is about 7% of the engine stroke. The inlet valve is also the piston of the combustion chamber and one of the boundaries of the combustion chamber. Since the combustion chamber reciprocates, the piston is nearly fixed. The inlet valve's position determines the volume of the combustion chamber. The inlet valve's position also controls the air charge to the combustion chamber. This is shown in FIGS. 6A & B. FIG. 6A shows a detailed partial sectional view of the combustion chamber during charging at full power or wide open throttle. FIG. 6B shows a detailed partial sectional view of the combustion chamber during charging at low power or nearly closed throttle. The position of the inlet valve, (110), in FIG. 6A allows full communication between the supercharger, (34), and combustion chamber, (32). The combustion chamber inlet ports, (60), are fully exposed. In addition, the combustion chamber is larger since the inlet valve is shifted upward (113). The position of the inlet valve in FIG. 6B restricts full communication between the supercharger and combustion chamber. In this figure, the inlet ports, (60), are nearly closed. In addition, the combustion chamber is smaller since the inlet valve is shifted downward.

This complimentary action, restricted air charge and reduced volume, allows a constant compression ratio at reduced power.

### Operation

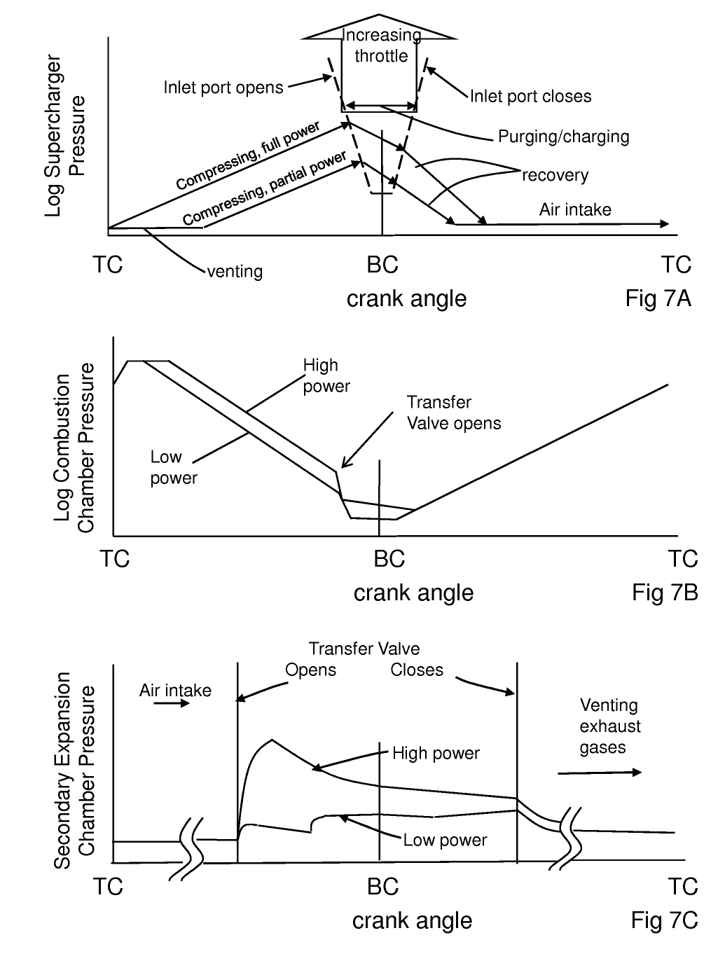

FIGS. 7 A-C show the pressure in each of the chambers for a complete cycle. The pressure is shown on a logarithmic scale because of its large dynamic range. FIG. 7 A shows the supercharger pressure starting at TC (top center of the stroke). At TC, the supercharger is at it maximum volume and compression begins. If the throttle is set to less than full power, the compression is delayed because the supercharger is vented. The supercharger is vented when the riser vents (116) align with the combustion chamber inlet ports. The alignment and consequent venting is proportional to the throttle position. Compression in the supercharger begins when venting (if any) is complete. The compression continues until the inlet ports are exposed and purging/Charging of the combustion chamber begins. At less than full throttle, purging/charging is delayed since the throttle obstructs the inlet port for part of the stroke. At the end of purging/charging, the inlet ports are closed. At this time the supercharger is a sealed volume at pressure greater than atmospheric. Since it is expanding, the pressure drops and the compressed air would return most of the work in compressing it. After the pressure has dropped below atmospheric, the reed valves allow air to enter the supercharger. FIG. 2B shows the reed valves located on the fixed partition. A alternate embodiment locates the reed valves on the supercharger piston. As much air will enter was used in the previous stroke.

The inlet ports are open an equal amount of time before and after Be. At full throttle, the ports are open and charging/purging occurs for about 30° before and 30° after Be. At low throttle, opening is less.

FIG. 7B shows the combustion chamber pressure for one cycle. The pressure varies by two orders of magnitude. Starting at TC, the air charge is compressed and ready for fuel injection and combustion. The pressure is the same for high and low power however the high power case has a larger volume. During combustion, the pressure, temperature and volume all increase. Then as the power stroke continues, the pressure drops. However the low power case drops quicker since it was a smaller volume initially. The period of decreasing pressure is the power stroke. When the transfer valve opens, the combustion chamber pressure drops rapidly as the secondary expansion chamber is pressurized. Purging! Charging occurs when the inlet ports are exposed. The purging/charging occurs quicker in the lower power case since the inlet ports are open for less of the stroke. The purging! Charging pressure is lower for the low power case. However the compression stroke starts earlier for the low power case and therefore the final pressure is the same.

FIG. 7C shows the pressure inside the secondary expansion chamber for one cycle. The abscissa of the graph is broken to reveal details near BC. Before the transfer valve open, the secondary expansion chamber is drawing in outside air through its reed valves. The pressure is essentially atmospheric. FIG. 2B shows the reed valves located on the fixed partition. They could be as effective if located on the secondary expansion piston. The pressure increases after the transfer valve opens and combustion gases enter the secondary expansion chamber. The secondary expansion chamber is pressurized to a greater pressure in the wide open throttle case. The secondary expansion chamber provides two significant advantages:

1) It allows simultaneous purging and charging of the combustion chamber. The back pressure in the secondary expansion chamber allows the supercharger to push the combustion gases into the secondary expansion chamber and pressurize (boost) the combustion chamber.

2) The cold air initially trapped in the secondary expansion chamber is heated by the combustion gases. The mixed gases have a net expansion and thus it converts thermal energy into additional power. The transfer valve closes at approximately bottom center and the secondary expansion chamber is sealed. Then the exhaust valve opens soon after the transfer valve closes. Now the exhaust gases are released over a relatively long period and at lower pressure. The exhaust gases are at a lower temperature because they have mixed with cold air, expanded more and released more energy. This reduces the engine noise.

1. A two-stroke internal combustion engine which utilizes an integrated positive displacement supercharger and secondary expansion chamber; comprising:
at least one cylinder housing assembly where the cylinder having an outward facing end, an inward facing end and, between the ends, a fixed annular partition extending radially inward in the cylinder and having a supercharger side and a secondary expansion side;
a double piston assembly encircled by the cylinder housing assembly, wherein the double piston assembly includes
a hollow cylindrical body having an outer end and an inner end and defining a combustion chamber;
an annular supercharger piston affixed at the outer end of the hollow cylindrical body, wherein said hollow body has circumferential perforations adjacent the supercharger piston; and a secondary expansion chamber piston affixed at the inner end of the hollow cylindrical body, wherein the secondary expansion chamber piston has at least one integrated exhaust valve suitable for fluid flow in the inward direction; and the inner end of the hollow cylindrical body is controllably sealed with an integrated transfer valve enabling fluid flow out of the combustion chamber in the inward direction with respect to the cylinder housing assembly;
in each cylinder, a supercharger chamber;
in each cylinder, a secondary expansion chamber separate from the supercharger chamber;
an inlet valve assembly at the outward facing end of each cylinder; and
a crankpin mounted on the cylinder housing assembly at the inward end of the secondary expansion chamber, the crankpin having integrated cam lobes to actuate at least one exhaust valve and being orientated such that the axis of the crankpin is perpendicular to the axis of the cylinder housing assembly
wherein the fluid flow out of the combustion chamber flows into the secondary expansion chamber, but fluid does not flow from the secondary expansion chamber into the combustion chamber.

2. The internal combustion engine according to claim 1, wherein each hollow cylindrical body is sealed at the outer end by the inlet valve assembly and sealed at the inner end by the transfer valve; wherein the combustion chamber receives air through the circumferential perforations from the supercharger chamber, receives fuel from the inlet valve assembly, and discharges combustion gases through the transfer valve into the secondary expansion chamber; wherein the hollow cylindrical body is operably associated with the crankpin; and wherein a cam lobe on the crankpin actuates said transfer valve.

3. The internal combustion engine according to claim 1, wherein the inlet valve assembly comprises a slideable inlet valve and a rotating riser encircling an injector barrel, each of the slidable inlet valve, rotating riser and injector barrel being concentrically aligned with the hollow cylindrical body, wherein rotation of the riser causes axial sliding motion of the inlet valve, thus controlling fluid communication from the supercharger chamber to the combustion chamber while altering the volume of the combustion chamber and thus maintaining a constant compression ratio within the combustion chamber.

4. The internal combustion engine according to claim 1, wherein the inlet valve assembly comprises a slideable inlet valve and a rotating riser encircling an injector barrel, the slidable inlet valve, rotating riser and injector barrel being concentrically aligned with the hollow cylindrical body, wherein rotation of the riser causes axial sliding motion of the inlet valve and alignment of the riser vents with the combustion chamber ports, thus controlling fluid venting from the supercharger chamber to the environment while altering the capacity of the supercharger chamber and altering the volume of the combustion chamber thus maintaining a constant compression ratio within the combustion chamber and independent of engine speed.

5. The internal combustion engine according to claim 1, wherein the supercharger chamber is defined by the cylinder on the outward facing end, the supercharger piston, the hollow cylindrical body and the fixed annular partition; wherein ambient air is drawn into the supercharger chamber through a plurality of one-way valves within said fixed annular partition; and wherein the air in the supercharger chamber is discharged into the combustion chamber through circumferential perforations in the hollow cylindrical body.

6. The internal combustion engine according to claim 5, wherein the supercharger chamber is self-regulated and returns any power consumed in compressing unused air to an output drive mechanism.

7. The internal combustion engine according to claim 1, wherein the supercharger chamber is defined by the cylinder on the outward facing end, the supercharger piston, the hollow cylindrical body and the fixed annular partition; wherein ambient air is drawn into the supercharger chamber through a plurality of one-way valves within said supercharger piston, said air fills the supercharger chamber, and the air in the supercharger chamber is fed into the combustion chamber through circumferential perforations in the hollow cylindrical body when the reciprocating combustion chamber exposes the circumferential perforations.

8. The internal combustion engine according to claim 7, wherein the supercharger chamber is self-regulated and returns any power consumed in compressing unused air to an output drive mechanism.

9. The internal combustion engine according to claim 1, wherein the secondary expansion chamber is defined by the cylinder on the inward facing end, the secondary expansion chamber piston, the hollow cylindrical body and the fixed annular partition; wherein ambient air is drawn in through a plurality of one-way valves within said fixed annular partition; the drawn in air partially fills the secondary expansion chamber; combustion gases as controlled by the transfer valve mix with the drawn in ambient air; and mixed gases are discharged to the environment as controlled by the at least one integrated exhaust valve; and, said at least one integrated exhaust valve is seated on the secondary expansion chamber piston and activated by a cam lobe on the crankpin.

10. The internal combustion engine according to claim 1, wherein the secondary expansion chamber is defined by cylinder on the inward facing end, the secondary expansion chamber piston, the hollow cylindrical body and the fixed annular partition; wherein ambient air is drawn in through a plurality of one-way valves within the secondary expansion chamber piston; the drawn in ambient air partially fills the secondary expansion chamber; combustion gases controlled by the transfer valve mix with the drawn in ambient air; and mixed gases resulting from the mixing of the combustion gases and the drawn in ambient air are discharged to the environment as controlled by at least one exhaust valve.

11. The internal combustion engine according to claim 10, wherein the at least one exhaust valve is seated on the secondary expansion chamber piston and activated by the crankpin.

12. The internal combustion engine according to claim 1, wherein the crankpin converts the reciprocating motion of the double piston assembly into rotary motion at a power take-off gear to insert or remove power.

13. The internal combustion engine according to claim 1, wherein the crankpin converts the reciprocating motion of the double piston assembly into rotary motion at a power take-off gear to insert or remove power and the crankpin functions as a camshaft to actuate the at least one exhaust valve and the transfer valve.

14. The internal combustion engine according to claim 1, wherein the secondary expansion chamber is defined by the cylinder on the inward facing end, the secondary expansion piston, the hollow cylindrical body, and the fixed annular partition; wherein ambient air is drawn in through a plurality of one-way valves within the secondary expansion chamber piston; said drawn in air partially fills the secondary expansion chamber; combustion gases as controlled by the transfer valve mix with the drawn in ambient air; and mixed gases are discharged to the environment as controlled by the at least one exhaust valve; and said at least one exhaust valve is integrated on the secondary expansion chamber piston and activated by cam lobes on the crankpin.

15. The internal combustion engine according to claim 1, wherein the inlet valve assembly has a fixed fuel injector barrel, a slideable inlet valve and a rotating riser.
